(19) United States
(12) Patent Application Publication
(10) Pub. No.: US 2005/0259909 A1
(43) Pub. Date: Nov. 24, 2005

(54) Fibre optic connectors and methods

(76) Inventors: Nigel B Aldridge, Gloucestershire (GB); Ian J Read, South Gloucestershire (GB); Peter D Foote, Gwent (GB)

Correspondence Address: NIXON & VANDERHYE, PC, 901 NORTH GLEBE ROAD, 11TH FLOOR, ARLINGTON, VA, 22203, US

(21) Appl. No.: 10/523,680

(22) PCT Filed: Dec. 21, 2004
(86) PCT No.: PCT/GB04/05376

§ 371 Date: Feb. 4, 2005

(30) Foreign Application Priority Data
Dec. 22, 2003 (GB) 0329641.5
Dec. 22, 2003 (EP) 03258124.1

(51) Int. Cl. G02B 6/12

(52) U.S. Cl. 385/14; 385/53

(57) ABSTRACT

One aspect of the invention provides a method for providing a connection between an embedded fibre optic (124) and a surface connector (144). The method comprises providing a substrate (100) comprising an embedded fibre connector component (120), forming a trench (110) to expose the embedded fibre connector component (120), and forming a fibre abutment connection between the embedded fibre connector component (120) and a fibre optic (142). The fibre optic (142) is suitable for guiding radiation between the embedded fibre connector component (120) and the surface connector (144).

### FIELD

The present invention relates to fibre optic connectors and methods. In particular, but not exclusively, it relates to fibre optic connectors and methods for providing an interface between a connector component embedded in a substrate material and the surface of that substrate. Such a substrate material may form, for example, a panel forming part of an aircraft structure.

### BACKGROUND

The provision of embedded waveguide structures to provide embedded sensing and/or embedded communication channels provides various known benefits. Where such waveguide structures are provided integrally within, for example, an aircraft, relatively light materials, such as, for example, optical fibres (fibre optics) may be provided, which are not only lighter than traditional metal wiring, but also relatively noise-immune and inexpensive.

While it is desirable to embed waveguide structures within panels that form a large structure, such as, for example, a building or aircraft, it has proved to be reasonably difficult and time consuming to provide reliable connections to such embedded waveguide structures, particularly during the process of manufacturing or assembly of the large structure.

Conventionally, to produce a panel, such as a composite panel for an aircraft incorporating an embedded waveguide, a waveguide (such as, for example, a fibre optic) is embedded in the composite panel and emerges from an edge of the panel from where it is terminated into a connector. However, not only are such so-called “edge connectors” labour intensive to produce, but they also place substantial limitations upon any subsequent modification to the panels. This in turn means that it has been necessary to provide a range of different panels of different shapes and sizes to assemble into the large structure. This not only increases the tooling costs and complexity involved in producing a complex large structure, but also gives rise to a requirement for intensive use of skilled labour capable of making the edge connectors.

Further, for certain applications, it may not be possible to use panels that include edge connectors which include so-called flying leads. Edge connectors can also make panel production more difficult, particularly where such panels are manufactured using a vacuum technique in which the panel is enveloped by a vacuum bag, since such vacuum bags tend to snap edge emerging fibres when a vacuum is being generated.

In order to address the problems associated with panels using edge connectors, and in particular in order to provide a panel that could be shaped after manufacture to allow, for example, for the removal of peripheral defects, the Applicants have previously devised various ways of interfacing to embedded waveguides. Various methods are discussed further in the Applicant's patent applications EP-A1-1,150,145 and EP-A1-1,150,150, the contents of which are hereby incorporated herein by reference in their entirety.

The aforementioned patent applications describe various ways of interfacing optical fibres, incorporated into components made using composite materials, to surface-mountable interface modules. The optical fibres are accessed from the surface of the components post-manufacture in order to leave the surface of the components free of incisions, cavities and the like during the assembly of various components into a large structure, such as, for example, an aircraft body.

While embedding of optical fibres and various interfacing components within a substrate, such as a composite material, can facilitate assembly of such a large structure, since waveguide connections can be made post-assembly, this approach is not without certain drawbacks. The interfacing components embedded in the substrate tend to be relatively bulky compared to fibre optics used to provide waveguides. Such bulky components displace a relatively large amount of substrate material. Incorporation of such interfacing components may thus weaken the substrate. Moreover, such bulky components are especially unsuitable where fairly thin substrates are required.

Conventionally, interfacing components providing an interface between an embedded fibre optic waveguide and a surface of the substrate have relied upon beam expansion to provide a collimated beam which can be accessed at the surface. Heavy reliance has been placed on the use of lenses, such as graded index (GRIN) lenses, and reflective corner cubes to provide expansion and redirection of the radiation emitted from, or coupled into, the fibre optic. Not only are such components bulky, with the associated disadvantages (hereinbefore described) that brings, but they are also expensive and relatively easily damaged/dirtied during handling.

The high cost of interfacing components, and their bulk, also discourages the widespread use of such interfacing components for providing redundant access points that may be used for connector formation. Accordingly, should a connector fail, it may render an entire substrate useless. Such a failure can thus necessitate subsequent remedial attention, such as replacement of a section of structure (for example, a full aircraft panel made from such a substrate) thereby wasting the expenditure of the time and effort needed to expose the previously embedded components of the defective panel/substrate.

Additionally, aligning, processing and coupling exposed interfacing components with other elements needed to form a connector can be difficult and is also time-consuming. This can in turn lead to the manufacture of a connector having sub-optimal alignment, finishing, polishing, etc., thereby leading to a connector having relatively high insertion and/or coupling losses.

Various techniques relating to the use of fibre optic components and/or embedding of fibre optic components into substrate structures may also be found in the following documents, the teachings of all of which are hereby incorporated herein by reference in their entirety: “Termination and connection methods for optical fibres embedded in aerospace composite components,” A. K. Green and E. Shafir, Smart Materials and Structures, Volume 8(2), pp. 269-273 (1999); “Optical fiber sensors for spacecraft applications,” E. J. Friebele et al, Smart Materials and Structures, Volume 8(6), pp. 813-838 (1999); “Development of fibre optic ingress/egress methods for smart composite structures,” H. K. Kang et al, Smart Materials and Structures, Volume 9(2), pp. 149-156 (2000); “Infrastructure development for incorporating fibre-optic sensors in composite materials,” A. K. Green et al, Smart Materials and Structures, Volume 9(3), pp. 316-321 (2000); and “Manufacturing technique for embedding detachable fiber-optic connections in aircraft composite components,” A. Sjögren, Smart Materials and Structures, Volume 9(6), pp. 855-858 (2000).

The aforementioned considerations and documents have been borne in mind when devising the various aspects and embodiments of the invention, as herein described.

### SUMMARY

According to a first aspect of the invention, there is provided a method for providing a connection between an embedded fibre optic and a surface connector. The method comprises providing a substrate comprising an embedded fibre connector component, forming a trench from a surface of the substrate to the embedded fibre connector to expose the embedded fibre connector component, and forming a fibre abutment connection between the embedded fibre connector component and a fibre optic. The fibre optic being for guiding radiation between the embedded fibre connector component and a surface connector.

Provision of an embedded fibre connector component allows a connection to be formed between the embedded fibre optic and a surface connector after the substrate has been formed. In this way, the components in the substrate can be protected while the substrate is incorporated into a large structure, such as for example, an aircraft/vehicle etc.

Moreover, the method may comprise providing a plurality of embedded fibre connector components in the substrate. This allows for the provision of redundant embedded fibre connector components, which may be used to provide a replacement connection after a large structure has been manufactured, for example, so as to replace a failed or broken connection.

The method may comprise locating an embedded element to identify the position of an embedded fibre connector component. For example, a commercially available AGFA C-scan device may be used. This device uses ultrasound to locate embedded fibre connector components. The embedded element may be the embedded fibre connector component itself, or may be provided as a separate embedded component. Such an embedded element may be located using techniques such as, for example, X-ray imaging. An embedded element may be endowed with one or more properties that can be used to identify the depth at which the embedded element is embedded in the substrate. For example, the size of the embedded element may indicate the depth at which it is embedded. The use of such embedded elements may therefore be used to provide information to an automated machining system operable to expose embedded fibre connector components associated with a respective embedded element. For example, an automated machining system may provide a trench to expose one or more embedded fibre connector components.

Embedded fibre connector components may be exposed by forming a trench from the surface of the substrate to the embedded fibre connector component(s). Such trenches may be formed by processing the substrate, for example, using laser cutting using one or more of: a CO, a CO2 and an Excimer laser. Laser cutting may be provided under machine control. For example, a laser cutting device may be operated under computer control to provide one or more predetermined trench profiles in a substrate.

Trench profiles may have various shapes. For example, a trench may have a shallow or gradually varying profile, such as, for example, a linear profile or a lazy S-shaped profile. By providing profiles that avoid sharp turns a trench may be used to accommodate a fibre optic without giving rise to significant bending losses. Use of such profiles may also allow the fibre optic to emerge from a substrate substantially parallel to the substrate surface. Trenches may also be used to embed connector components at or near to the surface, although in various embodiments connector components may be provided on an end of a fibre optic near the surface without the connector components being embedded either fully or partially in the substrate. The profile of a trench may also be used to guide fibre optics to an embedded fibre connector component from the surface when providing a fibre abutment connector.

Exposing the embedded fibre connector component may comprise removal of filler material from near to the embedded fibre connector component. Filler material may be provided in proximity to an embedded fibre connector component to help prevent ingress into the embedded fibre connector component of materials used during manufacture of the substrate, such as for example, epoxy resin. The embedded fibre connector component may be potted (i.e. affixed by embedding in a potting material, such as, for example, epoxy resin) into a recess in a substrate support layer. Subsequent removal of filler material may thus allow free access to an end of connector free from substrate material. Exposing the embedded fibre connector may also comprise removing a plug therefrom. Provision of a plug for an embedded fibre connector component can help prevent ingress of substrate material used during manufacture of the substrate.

Forming a fibre abutment connection may comprise providing self-aligning fibre optic and embedded fibre optic cores. Self-alignment may be provide by way of, for example, fibre optic ferrules aligned in a guide, such as, for example, a sleeve. Such a guide may be provided with a tapering portion in order to aid alignment of the fibre optic and embedded fibre optic cores. Provision for self-alignment allows the fibre optic and embedded fibre optic cores to be well-aligned. Such fibre abutment connections are also easy to make, while the components used are cheap and easy to manufacture. When forming a fibre abutment connection, index matching may be provided between the fibre optic and the embedded fibre optic. Provision of index matching can lead to an improved coupling efficiency. A fibre abutment connection may be sealed into the substrate. This allows the fibre abutment connection to be protected once it has been formed.

According to a second aspect of the invention, there is provided a method of manufacturing a substrate. The method comprises providing an embedded fibre optic optically connected to an embedded fibre connector component for forming a fibre abutment connection with a fibre optic. The embedded fibre optic and the embedded fibre connector are embedded in the substrate. The substrate may have a trench formed therein, possibly formed after the substrate has been incorporated into a large structure. The substrate may be used in the method according to the first aspect of the invention, and may included any or all of the features incorporated into a substrate as referred to herein.

A substrate material may comprise one or more composite material layers. By using one or more composite material layers as a substrate material, the substrate can be manufactured with a high strength-to-weight ratio. Moreover, by providing such composite layers, a substrate having predefined mechanical and/or physical parameters may be provided. For example, composite layers having respective fibres aligned in a particular arrangement may be used to tailor an aircraft panel so that it preferentially breaks in a particular predefined place when subject to a predetermined stress. For example, the material fibres may be selected from one or more of the following materials: plastic, carbon, glass, metal and Kevlar.

According to a third aspect of the invention, there is provided a substrate comprising an embedded fibre connector component. The substrate further comprises an embedded fibre optic optically connected to the embedded fibre connector component for forming a fibre abutment connection with a fibre optic. The substrate may have a trench formed therein, possibly formed after the substrate has been incorporated into a large structure. The substrate may be manufactured using the method according the second aspect of the invention.

The embedded fibre connector components may be used in a panel that provides communication between an embedded fibre optic and a surface connector component using, for example, UV, visible and/or infrared light. Such panels find use in many applications, such as, for example, for aircraft or motor vehicles.

By providing a connector that is accessible from a surface of the panel, various embodiments of the invention provide panels which can be machined post-manufacture, without damaging the panel or an embedded connector component, In order for them to be incorporated into, for example, an aircraft structure or a racing car body. Accordingly, various embodiments of the invention enable the manufacture of large structures incorporating embedded waveguides, such as aircraft or other vehicles, to be more efficiently produced. Additionally, such surface modules may have a low profile and/or be securely fixed to the substrate. Further, the provision of standard fibre optic connectors (such as, for example, HA, FC, FC/PC etc. connectors) at the surface of the substrate is facilitated.

According to a fourth aspect of the invention, there is provided a panel for a vehicle, such as, for example, an aircraft, where the panel is used for a fuselage, a component, a body or hull, comprising a substrate and/or embedded fibre connector component according to any of the aspects and/or embodiments herein described. According to a fifth aspect of the invention, there is provided an aircraft, or other vehicle, comprising a panel according to the fourth aspect of the invention. According to a sixth aspect of the invention, there is provided a method of manufacturing the vehicle according to the fifth aspect of the invention.

According to a seventh aspect of the invention, there is provided a connector component for providing a fibre abutment connection according to any of the aspects and/or embodiments herein described.

According to an eighth aspect of the invention, there is provided a machine system operable to expose an embedded fibre connector component according to any of the aspects and/or embodiments herein described. The machine system may be operable to control a CO, CO2 laser and/or an Excimer laser. The machine system may be operable under computer control. The machine system may be operable automatically to expose a trench of at least one predetermined profile. The machine system may be operable automatically to identify a depth and position of an embedded fibre connector component, identify a suitable predetermined trench profile for the identified depth, and create a trench corresponding to the suitable predetermined trench profile in order to expose an embedded fibre connector component. In various embodiments, the machine system may also be operable to identify the orientation of embedded fibre connector components and form one or more trench to access them accordingly.

According to an ninth aspect of the invention, there is provided a program product comprising a carrier medium having program instruction code embodied in the carrier medium. The program instruction code comprises instructions for configuring at least one data processing apparatus to provide the machine system according to the eighth aspect of the invention. The carrier medium may include at least one of the following set of media: a radio-frequency signal, an optical signal, an electronic signal, a magnetic disc or tape, solid-state memory, an optical disc, a magneto-optical disc, a compact disc and a digital versatile disc.

### BRIEF DESCRIPTION OF THE DRAWINGS

Embodiments of the present invention will now be described, by way of example only, with reference to the accompanying drawings where like numerals refer to like parts and in which:

FIG. 1 shows a cross sectional view of a substrate comprising an embedded fibre connector component, for use in accordance with various embodiments of the present invention;

FIG. 2a shows a cross sectional view of a trench formed in the substrate of FIG. 1, for use in accordance with various embodiments of the present invention;

FIG. 2b shows a plan view of the trench of FIG. 2a, for use in accordance with various embodiments of the present invention;

FIG. 3 shows a cross sectional view of a connector component providing a fibre abutment connection between the embedded fibre connector component of FIG. 1 and a fibre optic, for use in accordance with various embodiments of the present invention;

FIG. 4 shows a connector arrangement incorporating the fibre optic of FIG. 3 terminated into a surface connector, for use in accordance with various embodiments of the present invention;

FIG. 5 shows the connector arrangement of FIG. 4 embedded into a substrate, for use in accordance with various embodiments of the present invention;

FIG. 6 shows a cross sectional view of a trench formed in a substrate, for use in accordance with various embodiments of the present invention;

FIG. 7 shows a substrate support layer for fabricating a substrate for use in accordance with various embodiments of the present invention;

FIG. 8 shows the substrate support layer of FIG. 7, provided with an embedded fibre connector component for use in accordance with various embodiments of the present invention;

FIG. 9 shows the substrate support layer of FIG. 8 with the embedded fibre connector component embedded;

FIG. 10 shows a substrate for use in accordance with various embodiments of the present invention incorporating the substrate support layer of FIG. 9;

FIG. 11 shows a first embeddable fibre connector component and plug for use in accordance with various embodiments of the present invention;

FIG. 12 shows two end views of plugs for use in accordance with various embodiments of the present invention;

FIG. 13 shows a connector component for forming a fibre abutment connection with the embeddable fibre connector component of FIG. 11 for use in accordance with various embodiments of the present invention;

FIG. 14 shows a cross section through the connector component of FIG. 13;

FIG. 15 shows a second embeddable fibre connector component and plug for use in accordance with various embodiments of the present invention;

FIG. 16 shows a embeddable fibre connector component and plug for use in accordance with various embodiments of the present invention; and

FIG. 17 shows an aircraft system incorporating a substrate according to an embodiment of the present invention.

### DETAILED DESCRIPTION OF EMBODIMENTS OF THE INVENTION

FIG. 1 shows a cross sectional view of a substrate 100 having a surface 102 and comprising an embedded fibre connector component 120. The substrate 100 may be manufactured, for example, in accordance with a technique such as that described below in connection with FIGS. 5 to 10.

The embedded fibre connector component 120 is connected to an embedded fibre optic 124. One extremity of the embedded fibre connector component 120 is provided with a plug 122. The plug 122 serves to inhibit ingress of substances into the embedded fibre connector component 120. The fibre optic 124 comprises a fibre core surrounded by a fibre cladding. The fibre cladding is surrounded by a fibre jacket. The fibre optic 124 can be formed from standard telecommunications fibre, such as, for example, Coming SMF28 optical fibre that operates as single mode fibre when using light having a wavelength of 1550 nm.

The plug and the extremity of the embedded fibre connector component 120 to which the plug is attached are positioned within a cavity formed in the substrate 100. The cavity 100 is filled with filler material 150. The filler material 150 is an inert material that does not harden during the manufacture of the substrate 100 and/or which can be easily removed after the substrate 100 has been manufactured. For example, the filler material 150 may be elastomeric, potting material, or may be substrate host material, such as for example, a resin material.

By providing the plug 122 and a portion of the embedded fibre connector component 120 encapsulated in filler material 150, the plug 122 can be easily separated from the embedded fibre connector component 120 during processing to provide a fibre abutment connection, since the plug 122 does not come into contact with the material that forms the substrate 100.

An embedded element 152 is also provided within the cavity formed in the substrate 100. The embedded element 152 is bonded to the substrate 100 and disposed at a predetermined distance from the embedded fibre connector component 120. Various embedded elements 152 can be provided having, for example, a range of length each such length being indicative of a depth at which the embedded fibre connector component 120 is embedded.

Embedded elements 152 can be provided with various shapes and dimensions. In one example, the embedded elements 152 have a rectangular shape. The length of such rectangular elements can be used to provide depth information and also the orientation of the elements can be used to indicate the general orientation direction of an embedded fibre connector component 120. Such depth and/or direction information can be determined automatically and used as input parameters for various machine systems that are operable to expose embedded fibre connector components. The embedded elements 152 may be made of an inert material, such as, for example, a metal alloy like ARCAP which has a low-reactivity in the presence of the material(s) used to form the substrate 100. Use of such materials can provide embedded fibre connector components that have long term stability when embedded in a substrate.

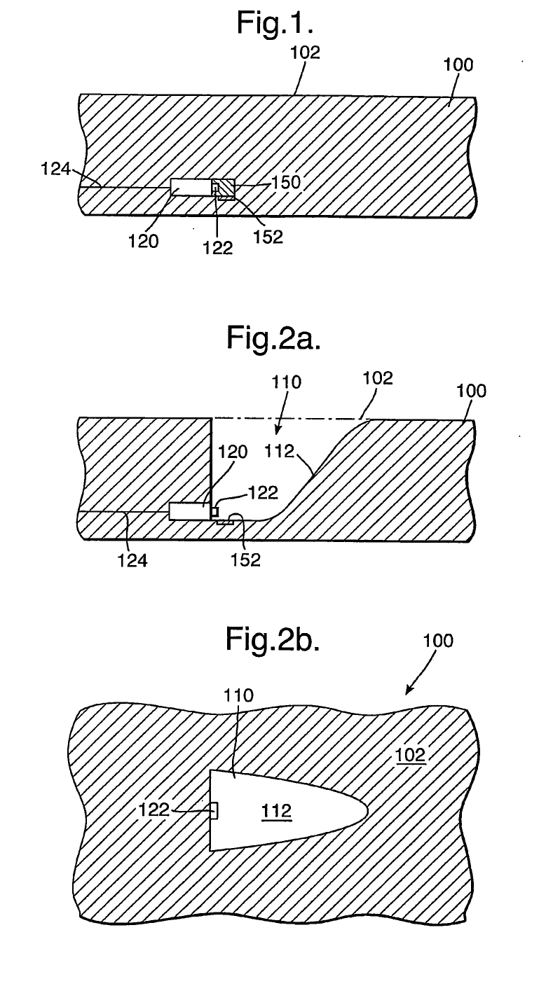

FIG. 2a shows a cross sectional view of a trench 110 formed in the substrate 100 of FIG. 1. The trench 110 extends from the surface 102 of the substrate 100 to the plug 122 and the embedded fibre connector component 120 coupled thereto.

The trench is formed by a scanning laser machining system (not shown). The scanning laser machining system excavates the trench 110 by controlling exposure of the substrate 100 to laser radiation. The profile 112 of the trench 110 can be determined by controlling the exposure time of the substrate 100, at various points in relation to the surface 102, to a beam of radiation. The radiation may comprise infra-red and/or ultra violet (UV) radiation, produced, for example, as a pulsed or continuous wave beam from one or more of: a CO, CO2 and an Excimer laser. An example of such a system is the LMC5010 Laser Machining Center, available from BEAM Dynamics Inc. of San Carlos, Calif., USA.

Various trench profiles 112 are possible. In the illustrated embodiment, the profile shown in cross section has a “lazy S-shaped” profile. The profile 112 curves in one direction on an increasingly steep gradient until it reaches a depth at approximately half way between the surface 102 and the depth of the embedded fibre connector component 120. The profile gradient then decreases until it lies approximately co-linearly with an axis passing through the embedded fibre connector component 120.

Once the trench 110 has been formed, or even when the cavity in the substrate 100 is opened during trench formation, the filler material 150 is removed. For example, where substrate resin material is used as a filler material 150, the filler can be removed by laser machining.

FIG. 2b shows a plan view of the trench 110 formed in the substrate 100. As is apparent from FIG. 2b, the profile 112 follows a two dimensional surface that extends from the surface 102 to the plug 122. The plug 122 is thus accessible in the trench 110 and can therefore be manipulated from within the trench 110. For example, various tools may be introduced into the trench 110 from above the surface 102 to attach to the plug 122 in order to facilitate removal of the plug 122. In various embodiments, such tools may include, for example, Allen keys, spanners and the like.

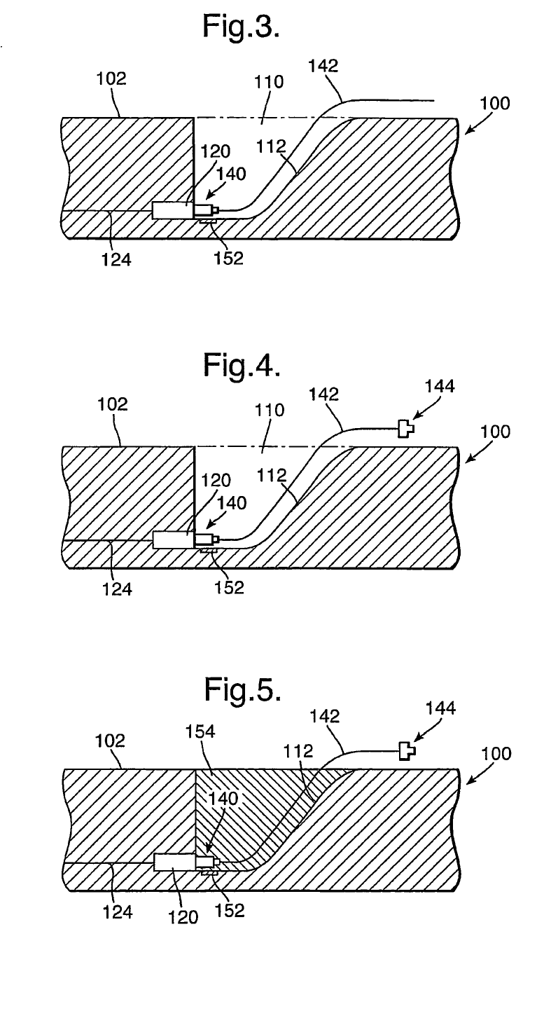

FIG. 3 shows a cross sectional view of a connector component 140 providing a fibre abutment connection between an embedded fibre connector component 120 and a fibre optic 142. The plug 122 has been removed to expose a portion of the embedded fibre connector component 120.

The connector component 140 is optically coupled to the fibre optic 142. Both the connector component 140 and the fibre optic 142 are introduced into the trench 110 from the surface 102 of the substrate 100. The connector component 140 is slid into the trench 110 and follows the profile 112. The profile 112 provides a path that has no sharp bends and so the fibre optic 142 has no portions in the trench 110 that give rise to substantial bending losses.

The connector component 140 is coupled to the embedded fibre connector component 120 in the trench 110 to form a fibre abutment connection therebetween. Various possible arrangements may be used to form the fibre abutment connection. For example, the embedded fibre optic 124 and the fibre optic 142 may both be terminated into ferrules providing polished fibre ends. The ferrules may be brought into close proximity in the embedded fibre connector component 120, thereby bringing the polished fibre ends into close proximity. Index matching may be used to enhance the coupling efficiency between the polished fibre ends. Such polished fibre ends may be optically and/or physically coupled. For example, Epo-Tek 353ND optical glue may be used to provide an indexed matched join. Various embodiments can make use of resiliently biased connector components to bring polished fibre ends into close proximity.

FIG. 4 shows the fibre optic 142 of FIG. 3 terminated into a surface connector 144. Either before or after the connector component 140 is coupled to the embedded fibre connector component 120 in the trench 110 to form the fibre abutment connection therebetween, the fibre optic 142 may be terminated into the surface connector 144. Many types of surface connector 144 are suitable. The surface connector can, for example, comprise a standard fibre optic connector component, such as HA, FC. FC/PC etc. to which an end of the fibre optic 142 is terminated. In various other embodiments, the fibre optic 142 may be used to provide a low-profile blister module that may be fitted close to the surface 102.

FIG. 5 shows the connector arrangement of FIG. 4 embedded into the substrate 100. The fibre optic 142 follows the profile 112 and emerges from the trench 110 above the surface 102. Once the fibre optic 142 has been coupled to the embedded fibre connector component 120 in the trench 110, the trench 110 can be potted with potting material 154 to embed the fibre abutment connection.

The potting step may take place either before or after any surface connector (such as surface connector 144) is provided. It is possible, for example, for the fibre optic 142 to be potted whilst a non-terminated end of the fibre optic 142 protrudes from the potting material 154 above the surface 102. Moreover, it is also possible to provide embedding for connectors, such as surface connector 144, either partially or completely in the potting material 154.

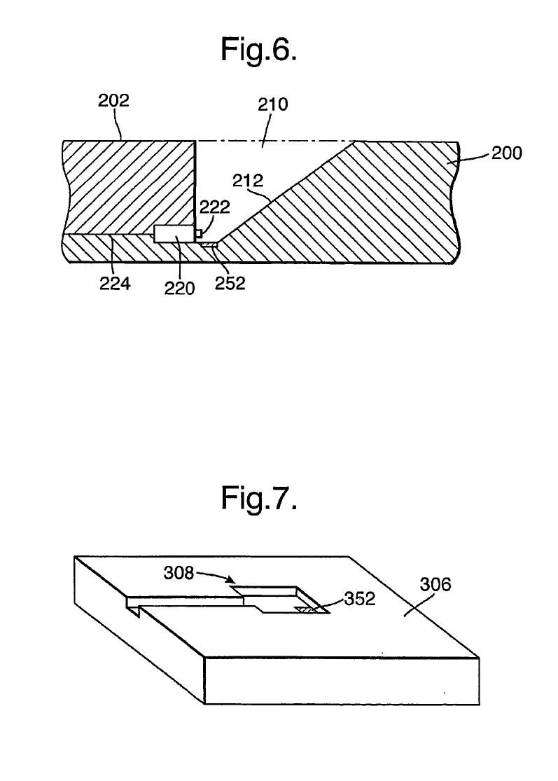

FIG. 6 shows a cross sectional view of a trench 210 formed in a substrate 200. The trench 210 extends from the surface 202 of the substrate 200 to the plug 222 and the embedded fibre connector component 220 coupled thereto.

The trench is formed by a scanning laser machining system (see above for details). The scanning laser machining system excavates the trench 210 by controlling exposure of the substrate 200 to laser radiation. The profile 212 of the trench 110 can be determined by controlling the exposure time of the substrate 200, at various points in relation to the surface 202, to a beam of radiation. The radiation may comprise infra-red and/or ultra violet (UV) radiation, produced, for example, as a pulsed or continuous wave beam from one or more of a CO, CO2 and an Excimer laser.

The profile 212 shown in cross section has a linear shaped profile. The profile 212 descends from the surface 202 linearly until it reaches the embedded element 252. Once the trench 210 has been formed, or even when the cavity in the substrate 200 is opened during trench formation, any filler material (not shown) is removed. Provision of a substantially linear profile 212 provides a path that has no sharp bends, thereby helping ensure that any fibre optic introduced into the trench 210 has no portions that give rise to substantial bending losses.

FIG. 7 shows a substrate support layer 306 for fabricating a substrate 300. The substrate support layer 306 has a recess 308 shaped to receive an embeddable fibre connector component 320 and an embeddable fibre optic 324. The recess 308 can be provided by machining the substrate support layer 306. For example, the substrate support layer 306 can be machined using a laser to provide a recess. Various formations may be provided in the recess 308 to support and/or orientate the embeddable fibre connector component 320 and/or the embeddable fibre optic 324. Embedded element 252 is disposed in the recess 308 and may be potted therein.

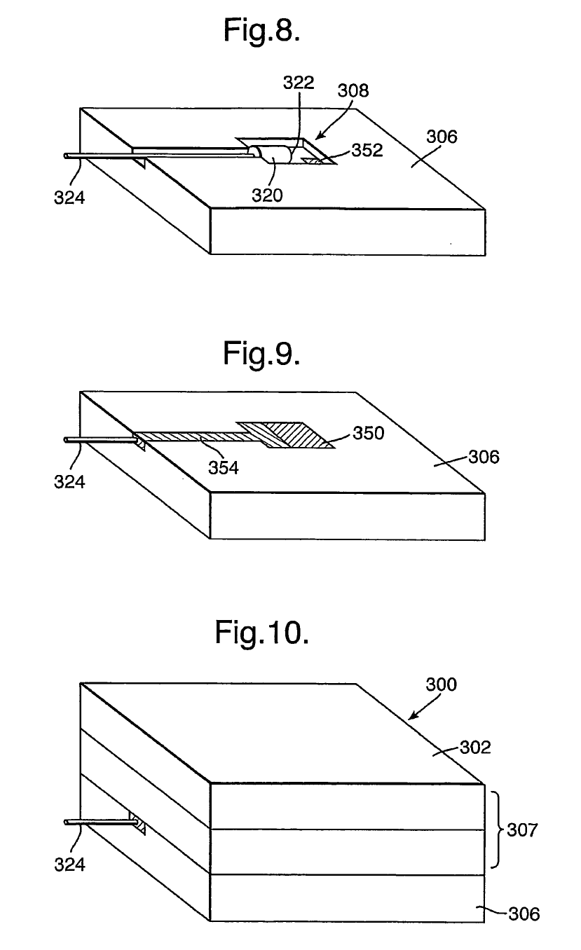

FIG. 8 shows the substrate support layer 306 provided with an embeddable fibre connector component 320 and an embeddable fibre optic 324 disposed in the recess 308. An end of the embeddable fibre connector component 320 is disposed at a predetermined distance from the embedded element 352.

FIG. 9 shows the substrate support layer 306 with the embeddable fibre connector component 320 and an embeddable fibre optic 324 now embedded in the recess 308. The fibre optic 324, the bulk of the embedded fibre connector component 320 and an end thereof connected to the fibre optic 324 are potted into a part of the recess 308 using potting material 354. Potting material 354, may for example, be two part epoxy resin, such as, for example, Araldite 2014, Araldite 2021 etc. The potting material 354 may also be the same or similar to a component material of a substrate/substrate support layer material.

The remainder of the recess 308 incorporating a part of the embeddable fibre connector component 320 having a plug 322 and the embedded element 352 are embedded in protective filler material 350. The filler material 350 may, for example, comprise potting material, substrate material etc.

FIG. 10 shows a substrate 300 incorporating the substrate support layer 306. The support layer 306 may be made using a variety of materials. Where, for example, the substrate support layer 306 is made using a composite material, it may be cured before, during or after potting of the embeddable fibre connector component 320 and/or fibre optic 324.

The embedded fibre connector component 320 may be completely sealed. Hence, it can be protected from the ingress of various materials (such as, for example, epoxy resin or a component thereof) that might be used during manufacture, e.g. the resin of composite materials.

The support layer 306 and material layers 307 are provided to make up the substrate 300. The material layers 307 may comprise composite materials. Where the substrate 300 comprises composite materials, consolidation tooling (not shown) may placed upon, or attached at, the surface 302. The consolidation tooling acts to compress the layers 306, 307, to ensure that the layers consolidate to a desired density and surface shape. Consolidation also helps provide a securely embedded fibre optic 102. Many forms of consolidation tooling are available, including, for example, a heavy weight or various tooling that positively engages the surface 302, for example by subjecting the substrate 300 to a partial vacuum, such consolidation tooling may comprise a vacuum bag provided over the surface 302.

Composite materials that are used to provide a substrate 300, or a part thereof, generally need to be cured. Curing can be implemented by various methods such as chemical, pressure and/or heat induced variations in the physical/chemical composition of a resin, either impregnated into fibres or found in layers pre-impregnated with a resin material.

As an example, the substrate 300 may be made using a plurality of composite material layers that have been pre-impregnated with BMI resin material. For this material, the substrate 300 is subject to a temperature of 190° C. for 7 hours at a pressure of 100 psi, before being subject to a post-cure temperature of 245° C. Where standard epoxy resin is used, the substrate 300 is subject to a temperature of 175° C. for 5 hours at a pressure of 90 psi, before being subject to a post-cure temperature of 210° C. Where various other materials are used, a post-cure step may not be necessary.

Another technique to make a composite material is to use a resin transfer moulding (RTM) technique. The RTM technique uses fibre pre-form layers that are placed into a closed mould. Resin is injected into the mould at low pressure (<100 psi for thermosetting resin, subsequently cured at a temperature of 175° C. at 70 psi) to fill the voids in the fibre pre-form layers. The mould is then subject to a curing treatment to create the composite material.

Once any curing process has taken place, any consolidation tooling is removed from the substrate 300, any additional processing, such as, for example, polishing, fitting and/or machining can be undertaken.

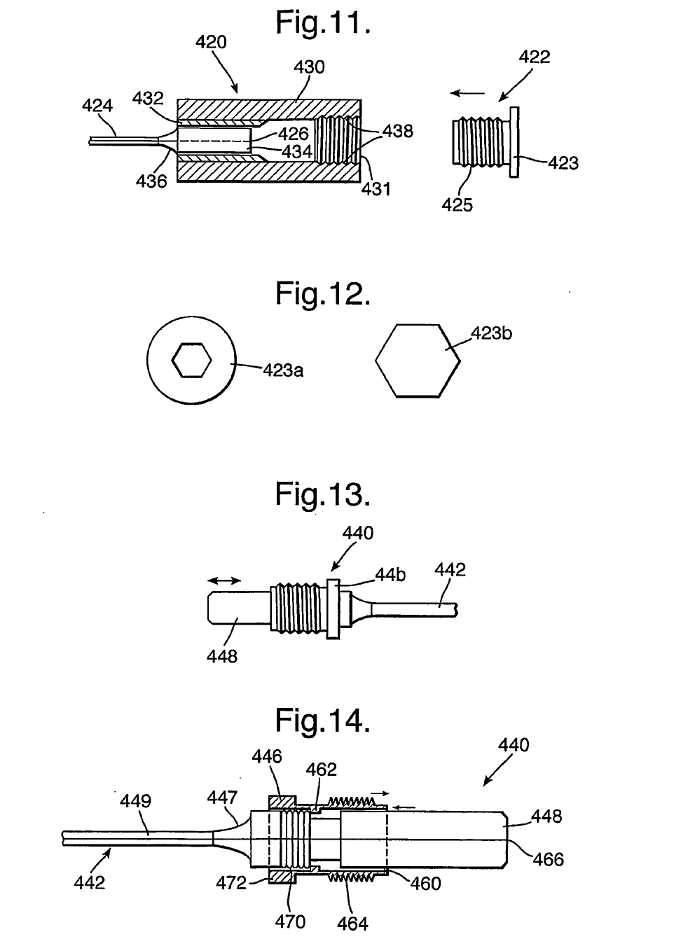

FIG. 11 shows a first embeddable fibre connector component 420 and plug 422 for embedding in a substrate.

The embeddable fibre connector component 420 comprises an outer casing 430 having a bore 431 in which is disposed a guide 432. The outer casing 430 additionally has a threaded portion 438 formed in the bore 431 proximal to one of its ends. Provision of the threaded portion 438 allows for coupling of the plug 422, and may also be used for attaching components once the embeddable fibre connector component 420 is embedded. The guide 432 accommodates a ferrule 434 coupled to an embeddable fibre optic 424. Such a guide 432 can be formed as an integral part of the casing 430. The ferrule 434 may be of standard design and size and can be formed as part of, or bonded/fixed into, the ferrule 434. For example, Kyocera ceramic OP1195a/000000 ferrules may be used. A fibre boot 436 is provided to protect the fibre optic 424 close to the region where it passes into the embeddable fibre connector component 420.

The guide is also shaped to receive a further ferrule (not shown) and to guide the further ferrule so that the fibre cores of fibre optics housed in the ferrule 434 and the further ferrule are brought into alignment. The outer casing 430, the guide 432 and/or the ferrule 434 may be made of an inert material, such as, for example, a metal alloy like ARCAP which has a low-reactivity in the presence of material(s) used to form a substrate.

The plug 422 is configured to fit into the bore 431 in order to inhibit the ingress of material into the bore 431 when the embeddable fibre connector component 420 is embedded. The plug 422 comprises a neck portion disposed with a threaded portion 425. The threaded portion 425 is connectable to the threaded portion 438 of the bore 431. The plug additionally comprises a flange end portion 423 that abuts against the end of the outer casing 430 when the plug is in situ. The diameter of the threaded portion 438 can be made less than the diameter of the outer casing 430 to reduce the chance that the plug 422 come into contact with any substrate material which could make it difficult to remove.

FIG. 12 shows end views of plug flange end portions 423a, 423b. The flange end portion 423a has a circular outer shape provided with a hexagonal recess for engaging an Allen key. The flange end portion 423b has a hexagonal outer shape for engaging with a spanner. The flange end portions 423a, 423b allow plugs 422 that have been exposed in a substrate to be manipulated using tools provided above a surface of the substrate. Various other suitable configurations of plugs and/or embeddable fibre connector components will also be apparent to those skilled in the art.

FIG. 13 shows a connector component 440 for forming a fibre abutment connection with the embeddable fibre connector component 420. The connector component 440 comprises a fibre optic 442 terminated into a ferrule 448. The ferrule 448 is resiliently biased and slideably mounted in a connector housing 446. The connector housing 446 can be releaseably coupled to the embeddable fibre connector component 420. The resilient biasing acts to urge the ferrule 448 against the ferrule 434 when the connector component 440 is coupled to the embeddable fibre connector component 420.

FIG. 14 shows a cross section though the connector component 440. The fibre optic 442 is terminated into the ferrule 448 by stripping fibre optic jacket 449 from a portion of the fibre optic 442 to reveal a stripped fibre potion 466. The stripped fibre potion 466 is fed into the ferrule 448, bonded and then polished to provide the termination. The fibre optic 442 is also potted to the ferrule 448 using potting material 447. The potting material 447 helps to strengthen the connection between the fibre optic 442 and the ferrule 448. The ferrule 448 is provided with an annular groove 468.

The connector housing 446 is provided with a channel 460. An annular formation 462 projects from the connector housing 446 into the channel 460. The annular formation 462 is sited within the annular groove 468 and serves to provide a slideable coupling between the ferrule 448 and the connector housing 446, and also limits the extent of the relative movement between the ferrule 448 and the connector housing 446. A coil spring 470 is provided in the annular groove 468. The coil spring 470 acts to exert a resilient biasing force between the ferrule 448 and the annular formation 462. The resilient biasing force serves to urge the ferrule 448 against the ferrule 434 when the connector component 440 is coupled to the embeddable fibre connector component 420.

The connector housing 446 also comprises a threaded portion 464 for coupling to the threaded portion 438 provided in the embeddable fibre connector component 420. Further, the connector housing 446 comprises a collar 472, that may be knurled, and which enables the connector housing 446 to be gripped in order that it can be turned to engage the threaded portion 464 with the threaded portion 438.

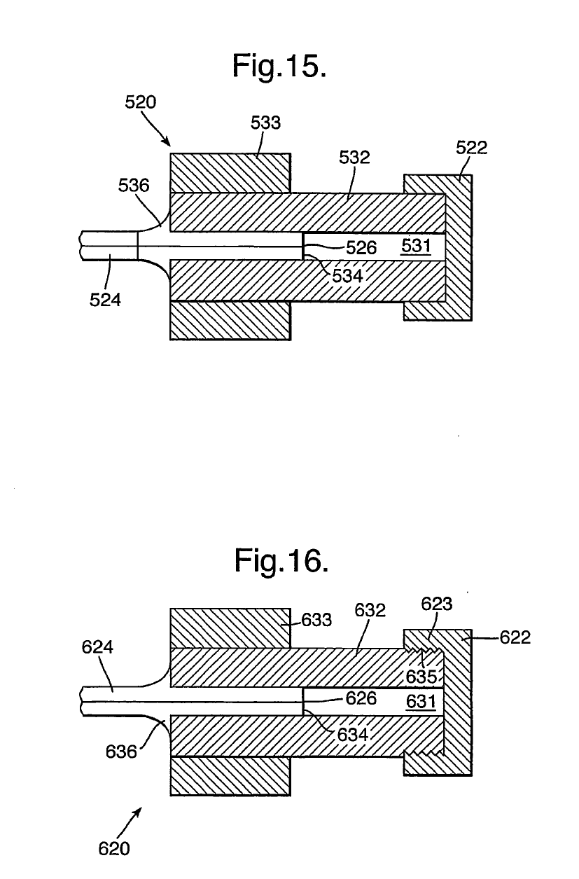

FIG. 15 shows an embeddable fibre connector component 520 and plug 522. The embeddable fibre connector component 520 comprises a flange portion 533 and a sleeve 532. The flange portion 533 and the sleeve 532 may be formed as a single element, for example, by casting and/or machining of an inert material, such as, for example, a metal alloy like ARCAP.

The flange portion 533 is provided to facilitate positioning of the embeddable fibre connector component 520. For example, where the embeddable fibre connector component 520 is to be provided is a recess formed in a substrate support layer, the flange potion 533 provides a convenient means for spacing the sleeve from the surfaces bounding the recess. Spacing of the sleeve from the surfaces bounding the recess permits the end of the sleeve to be provided in the recess without contacting the surfaces bounding the recess. This enables the plug 522 to be easily removed and the end of the sleeve therebeneath to be easily accessed.

The sleeve 532 is provided with a bore 531 in which is disposed a ferrule 534 coupled to an embeddable fibre optic 524. The ferrule 534 may be of standard design and size and can be formed as part of, or bonded/fixed into, the ferrule 534. A fibre boot 536 is provided to protect the fibre optic 524 close to the region where it passes into the embeddable fibre connector component 520. The bore 531 is also adapted to receive a further ferrule coupled to a fibre optic (not shown) and to guide the further ferrule so that the fibre optics are brought into alignment.

The plug 522 is configured to fit over the end of the sleeve 532 in order to inhibit the ingress of material into the bore 531 when the embeddable fibre connector component 520 is embedded. The plug 522 fits snugly over the end of the sleeve 532 and is retained in place by friction. The plug 522 may be made, for example, from rubber, hard plastics, metal etc. The plug may be attached by gluing. Plugs may incorporate additional seals, such as, for example, an O-ring. Various plugs can also be designed to be removed by breaking the plug and/or part of an embedded fibre connector component. The diameter of the plug 522 may be made less than that of the flange portion 533 in order to allow the plug to be more easily accessed/removed following embedding of the embeddable fibre connector component 520.

FIG. 16 shows an embeddable fibre connector component 620 and plug 622. The embeddable fibre connector component 620 comprises a flange portion 633 and a sleeve 632. The flange portion 633 and the sleeve 632 may be formed as a single element, for example, by casting and/or machining of an inert material, such as, for example, a metal alloy like ARCAP. The flange portion 633 may be provided to facilitate positioning of the embeddable fibre connector component 620.

The sleeve 632 is provided with a bore 631 in which is disposed a ferrule 634 coupled to an embeddable fibre optic 624. The ferrule 634 may be of standard design and size and can be formed as part of, or bonded/fixed into, the ferrule 634. For example, a standard ferrule may be fitted into a further sleeve. A fibre boot 636 is provided to protect the fibre optic 624 close to the region where it passes into the embeddable fibre connector component 620. The bore 631 is also adapted to receive a further ferrule coupled to a fibre optic (not shown) and to guide the further ferrule so that the fibre optics are brought into alignment.

The plug 622 is configured to connect to the end of the sleeve 632 in order to inhibit the ingress of material into the bore 631 when the embeddable fibre connector component 620 is embedded. The plug 622 comprises a threaded portion 623 that engages with a co-operating threaded portion 635 formed on the sleeve 632. The plug 622 may be made, for example, from metal (e.g. ARCAP), rubber, plastic etc. The diameter of the plug 622 may be made less than that of the flange portion 633 in order to allow the plug to be more easily accessed/removed following embedding of the embeddable fibre connector component 620.

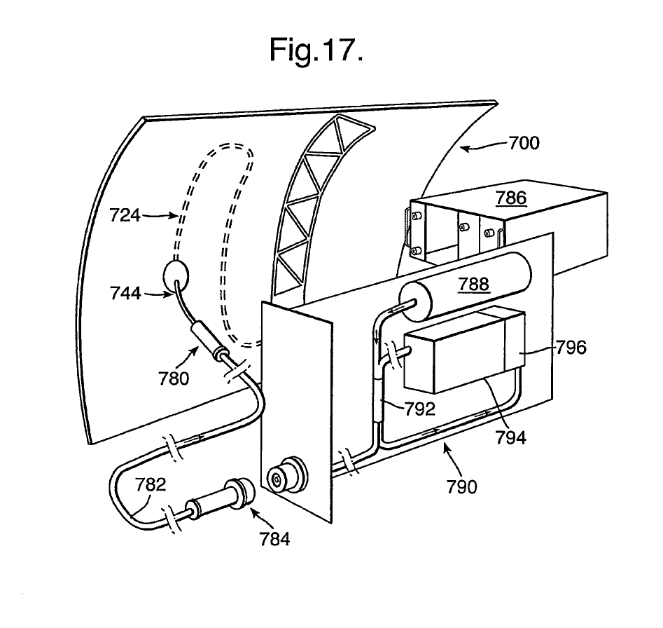

FIG. 17 shows an aircraft system incorporating a substrate 700 made of a composite material. The substrate 700 incorporates an embedded fibre sensor 724 embedded the substrate 700 connected via a fibre abutment connection to a partially embedded connector component 744. The embedded fibre sensor 724 is interrogated by inputting pump radiation through a surface connector component 780 and analysing any retro-propagating radiation.

The surface connector component 780 connects to an avionics card module 790, housed in an avionics rack 786, via fibre cable 782 and fibre connector 784. The avionics card module 790 comprises a fibre coupler 792 for splitting a pump radiation beam generated by a broadband light source 788. Part of the split pump radiation is directed to the fibre connector 784 for transmittal to the embedded fibre sensor 724, and the other part is directed to photodiode 796. Retro-propagating radiation from the embedded fibre sensor 724 is directed via the fibre coupler 792 to tuneable filter 792. Analysis of the photodiode 796 and/or tuneable filter 794 outputs enables information relating to the physical state of the embedded fibre sensor 724, and thus the composite material forming the substrate 700, to be determined.

Use of fibre abutment connections of the type described herein allows waveguides, such as fibre optics, to be embedded at various controllable depths within a substrate material. Such optical connector arrangements can also provide low loss connections from such an embedded waveguide to a surface module or connector. Many such optical connector arrangements will be apparent to those skilled in the art. Various embodiments of the invention provide that edge trimming of panels incorporating the waveguide assembly, which is often necessary when fitting such panels to, for example, an aircraft frame, does not affect the optical connector arrangements. Moreover, such optical connector arrangements may provide surface accessible connectors to which low-profile surface connectors may be easily attached.

Fibre abutment connections can be relatively low cost, thereby making them attractive for use as redundant embedded fibre connector components. They also may have a relatively small size and can thus be included in a substrate without greatly affecting the strength of the substrate. Such fibre abutment connections are suited to use in relatively thin substrates. Moreover, since fibre abutment connections do not require beam expansion optics, they can be used to provide low-loss connections.

Furthermore, as fibre optics connected to various embedded fibre connector component embodiments may emerge from the surface of a substrate at a relatively shallow angle, various embodiments of the invention may provide low-profile connector arrangements that have a reduced susceptibility to shocks/knocks.

Those skilled in the art will be aware that fibre optics could be substituted for various waveguides that may be single/multimode. Such a waveguide may be selected for single and/or multimode operation at various wavelengths, such as, for example, one or more of: UV, visible, near-infrared and infrared wavelengths. Those skilled in the art will also be aware that numerous schemes may be used to provide a fibre abutment connector in which fibre cores are brought into close proximity: for example, fibre cores may be located in close proximity to provide for an evanescent coupling through fibre cladding material, as is well known in the art.

Those skilled in the art will be aware that due to the principle of the reciprocity of light, the various connectors, connections etc. described herein can be used to couple radiation (such as, for example, UV, optical radiation, infrared radiation etc.) both from and into various fibre optics. In the discussions herein, it is understood that this principle of reciprocity applies to all embodiments and aspects of the invention.

A fibre optic may be completely or partially embedded in the support layer/substrate. A fibre optic may be terminated into various connectors as desired. Such connectors may be fully or partially embedded at a surface of a substrate, or they may be free of the substrate surface. Such connectors may be standard commercially available connectors, such as, for example, HA, FC, and/or FC/PC etc. A plurality of fibre embedded connector components and/or different types of fibre may be provided along the length of an embedded fibre optic. Various substrate recesses may be provided, such as, for example, slots.

Those skilled in the art will also be aware that in various embodiments substrate materials may comprise composite materials. Additionally, those skilled in the art will realise that various optical connector arrangements can be provided on one or more surfaces of a substrate. Both the substrate and/or any layers forming a part thereof may comprise composite materials. Such composite materials may, for example, be made using layers of material comprising generally aligned fibres of plastic, glass, carbon, metal and/or Kevlar, impregnated or pre-impregnated with a resin material, and combinations of two or more such materials. The general orientation of the fibres of neighbouring layers can be varied to provide enhanced mechanical properties in the finished composite material. In other embodiments, materials having non-generally aligned strengthening fibres may be used. Those skilled in the art will also be aware that one or more embeddable fibre connector component may merely by inserted between substrate layers, without the need to provide machined layers.

Those skilled in the art will realise that embedded fibre connector components may be sealed using a number of techniques prior to any subsequent exposure. For example, embedded fibre connector components may be potted into a recess using substrate host material. Substrate and/or filler material may be removed. Plugs may be removed by, for example, merely pulling them out. Such plugs may be made of resilient material such as a rubber compound. In various embodiments, a portion of an embedded fibre connector component and/or a plug may be designed to snap-off, or, for example, be removed by grinding-off, in order to expose a part of the embedded fibre connector component.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A method for providing a connection between an embedded fibre optic and a surface connector, the method comprising:
providing a substrate comprising an embedded fibre connector component;
forming a trench from the surface of the substrate to the embedded fibre connector to expose the embedded fibre connector component; and
forming a fibre abutment connection between the embedded fibre connector component and a fibre optic, wherein the fibre optic is for guiding radiation between the embedded fibre connector component and a surface connector.

2. The method of claim 1, further comprising providing a plurality of embedded fibre connector components.

3. The method of claim 1, comprising locating an embedded element to identify the position of the embedded fibre connector component.

4. The method of claim 3, comprising endowing the embedded element with one or more properties that can be used to identify the depth at which the embedded element is embedded in the substrate.

5. The method of claim 1, wherein the trench is for guiding the fibre optic towards the embedded fibre connector component for forming the fibre abutment connection.

6. The method of claim 5, wherein the trench is formed by operating a CO laser and/or an Excimer laser operated under machine control.

7. The method of claim 5, wherein the trench has a linear profile or a lazy S-shaped profile.

8. The method of claim 1, wherein exposing the embedded fibre connector component comprises removing a filler material from proximal to at least a portion of the embedded fibre connector component.

9. The method of claim 1, wherein exposing the embedded fibre connector component comprises removing a plug therefrom.

10. The method of claim 1, wherein forming a fibre abutment connection comprises providing self-aligning fibre optic and embedded fibre optic cores.

11. The method of claim 1, wherein forming a fibre abutment connection comprises providing index matching between the fibre optic and the embedded fibre optic.

12. The method of claim 1, comprising sealing the fibre abutment connection into the substrate.

13. A method of manufacturing a substrate, comprising:
providing an embedded fibre optic optically connected to an embedded fibre connector component for forming a fibre abutment connection with a fibre optic, wherein the embedded fibre optic and the embedded fibre connector are embedded in the substrate; and
forming a trench from a surface of the substrate to the embedded fibre connector to expose the embedded fibre connector component.

14. The method of claim 13, comprising providing an embedded element for identifying the position of the embedded fibre connector component proximal to the embedded fibre connector component.

15. The method of claim 13, wherein the embedded element is endowed with one or more properties that can be used to identify the depth at which the embedded element is embedded in the substrate.

16. The method of claim 13, comprising providing a filler material proximal to at least a portion of the embedded fibre connector component.

17. The method of claim 13, comprising providing the embedded fibre connector component with a plug.

18. The method of claim 13, comprising providing guide for aligning a fibre optic core with a fibre core of the embedded fibre optic.

19. The method of claim 13, comprising providing one or more composite material layers to form the substrate.

20. The method of claim 19, wherein each composite material layer comprises respectively aligned material fibres.

21. The method of claim 20, further comprising selecting the material fibres from one or more of the following materials: plastic, carbon, glass, metal and Kevlar.

22. The method of claim 13, comprising potting the embedded fibre connector component into a recess in a substrate support layer.

23. The method of claim 13, further comprising providing a plurality of embedded fibre connector components within the substrate.

24. A substrate comprising an embedded fibre connector component and an embedded fibre optic optically connected to the embedded fibre connector component for forming a fibre abutment connection with a fibre optic, wherein the substrate further comprises a trench formed from a surface of the substrate to the embedded fibre connector component.

25. The substrate of claim 24, further comprising an embedded element for identifying the position of the embedded fibre connector component, wherein the embedded element is sited proximal to the embedded fibre connector component.

26. The substrate of claim 24, wherein the embedded element is endowed with one or more properties that can be used to identify the depth at which the embedded element is embedded in the substrate.

27. The substrate of claim 24, further comprising a filler material provided proximal to at least a portion of the embedded fibre connector component.

28. The substrate of claim 24, wherein the embedded fibre connector component is provided with a plug.

29. The substrate of claim 24, wherein the embedded fibre connector component is provided with a guide for aligning a fibre optic core with a fibre core of the embedded fibre optic.

30. The substrate of claim 24, comprising one or more composite material layers.

31. The substrate of claim 30, wherein each composite material layer comprises respectively aligned material fibres.

32. The substrate of claim 31, wherein material fibres comprise one or more of the following materials: plastic, carbon, glass, metal and Kevlar.

33. The substrate of claim 24, wherein the embedded fibre connector component is potted into a recess in a substrate support layer.

34. The substrate of claim 24, comprising a plurality of embedded fibre connector components.

35. A panel for a vehicle fuselage, component, body of hull, comprising the substrate according to claim 24.

36. A vehicle comprising a panel according to claim 35.

37. A method of manufacturing a vehicle, comprising incorporating a panel according to claim 35 into a vehicle fuselage, component, body or hull.

38. A connector component for providing a fibre abutment connection between a fibre optic and the embedded fibre connector component(s) of claim 24.

39. A machine system operable to expose the embedded fibre connector component according to claim 1.

40. The machine system of claim 39, further operable to control a CO laser and/or an Excimer laser.

41. The machine system of claim 39, operable under computer control.

42. The machine system of claim 39, operable automatically to expose a trench of at least one predetermined profile.

43. The machine system of claim 42, operable automatically to: identify a depth and position of an embedded fibre connector component; identify a suitable predetermined trench profile for the identified depth; and create a trench corresponding to the suitable predetermined trench profile in order to expose the embedded fibre connector component.

44. A program product comprising a carrier medium having program instruction code embodied in the carrier medium, the program instruction code comprising instructions for configuring at least one data processing apparatus to provide the machine system according to claim 39.

45. The program product according to claim 44, wherein the carrier medium includes at least one of the following set of media: a radio-frequency signal, an optical signal, an electronic signal, a magnetic disc or tape, solid-state memory, an optical disc, a magneto-optical disc, a compact disc and a digital versatile disc.

46-54. (canceled)
